(19) United States
(12) Patent Application Publication
(10) Pub. No.: US 2011/0021405 A1
(43) Pub. Date: Jan. 27, 2011

(54) Continuous Process for Making a Laundry Detergent Composition

(75) Inventors: Nigel Patrick Somerville Roberts, Newcastle upon Tyne (GB); Hossam Hassan Tantawy, Northumberland (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/893,315

(22) Filed: Sep. 29, 2010

Related U.S. Application Data
(63) Continuation of application No. PCT/US2010/041118, filed on Jul. 7, 2010.
(60) Provisional application No. 61/224,160, filed on Jul. 9, 2009.

(51) Int. Cl. C11D 17/06

(52) U.S. Cl. 510/276

(57) ABSTRACT

A continuous process for making a solid particulate laundry detergent composition having the steps of: (a) forming a soft surfactant particle having a cake strength of from about 30N to about 200N; and (b) contacting the soft surfactant particle with a free-flowing heterogeneous particulate mixture having multiple chemically distinct detergent particle populations, wherein said free-flowing heterogeneous particulate mixture has a cake strength of from about 0N to about 20N, wherein the free-flowing heterogeneous particulate mixture has a weight average particle size of from about 50 micrometers to 2000 micrometers, and wherein the ratio of (i) the cake strength of the soft surfactant particle in N to (ii) the time between step (a) and step (b) in minutes is in the range of from 6Nmin⁻¹ to 2000Nmin⁻¹.

### CROSS REFERENCE TO RELATED APPLICATION(S)

This application is a Continuation of International Application No. PCT/US2010/041118, filed Jul. 7, 2010, which claims the benefit of U.S. Provisional Application No. 61/224,160, filed Jul. 9, 2009.

### FIELD OF THE INVENTION

The present invention relates to a continuous process for preparing a particulate laundry detergent composition. The process of the present invention provides a process that is improving the formulation space of the resultant laundry detergent composition, and improves the flexibility of the process enabling the handling of materials and levels of materials which would otherwise necessitate the use of additional otherwise unnecessary detergent ingredients.

### BACKGROUND OF THE INVENTION

The present invention relates to a continuous process for making a particulate laundry detergent composition. Particulate laundry detergent compositions comprise multiple different particle types (particle populations), including for example: surfactant agglomerates; spray-dried powder; bleach dry-added particles, such as coated percarbonate particles; enzyme prills; filler dry added particles such as sodium sulphate particles; sodium carbonate particles, perfume particles; and polymer particles. Typically, each one of these separate particles are prepared in one location, collected (e.g. bagged) and transported to another location where they are blended together, usually in a continuous process, to form the laundry detergent composition.

This means that each one of these particle populations need to have adequate physical characteristics that allows them to be collected, stored, transported, stored again, and finally dosed into the final continuous process. For example, a surfactant agglomerate is produced in an agglomeration unit in one location. This surfactant agglomerate needs to have adequate flow properties (e.g. be crisp enough and flowable enough) to enable it to be collected and transported to another location (which is sometimes in another country or even continent) to be accurately dosed with other particles such as spray-dried powder to form a laundry detergent composition.

This requirement for adequate flowability, physical characteristics, and to some extent stability, of each individual particulate component of the laundry detergent composition, places a great constraint to the formulation space, range and levels of ingredients that are available to the detergent formulator, and impedes the process efficiency and process rate (e.g. production capacity).

This is especially true for materials such as surfactants (especially ethoxylated alkyl sulphates) where in order to ensure adequate flowability and crispness of each individual surfactant particle, one cannot incorporate high levels of such surfactants into the particle and still be able to collect, store and transport it adequately. In addition to this, due to the need for each individual surfactant particle per se to have adequate physical properties, otherwise unnecessarily high levels of ingredients (e.g. process aids, such as zeolite and sodium sulphate) are incorporated into the particle along with the surfactant. This takes up valuable formulation space, and adds cost to the formulation and process.

The inventors have overcome the above problems by coupling the surfactant particle making process directly to the continuous process. This eliminates the need to collect, store and transport the surfactant particles, meaning that much softer surfactant particles can be used. This enables higher surfactant levels, or stickier and harder to handle surfactants, to be incorporated into the finished product and reduces the reliance on process aids.

### SUMMARY OF THE INVENTION

The present invention relates to a process as defined by claim 1.

### DETAILED DESCRIPTION OF THE INVENTION

### A Continuous Process

The continuous process comprises the steps of: (a) forming a soft surfactant particle; and (b) contacting said soft surfactant particle with a free-flowing heterogeneous particulate mixture comprising multiple chemically distinct detergent particle populations. The steps (a) and (b), the soft surfactant particle, the free-flowing heterogeneous particulate mixture and the chemically distinct detergent particle populations are described in more detail below.

For the purpose of the present invention, by continuous process it is meant a process that makes a solid particulate laundry detergent composition, in such a manner that there is no interruption in the final stream of fully formulated solid particulate laundry detergent composition. Of course, it is within the scope of the present invention to allow the end product after it has been made by the process, i.e. the solid particulate laundry detergent composition, to be collected in holding systems, such as bags, buggies, silos and the like, and then to be transported to packing systems.

Whilst the process of the present invention is continuous, some feeder systems may be semi-continuous. For example, drop tanks holding components to be fed into the continuous process whilst having a continuous exit-stream, may be filled by a series of individual batch inputs.

Preferably, it is important to control the time between steps (a) and (b). It is particularly preferred to control this time gap in relation to the compressibility of the soft surfactant particle. The time gap between steps (a) and (b) must be shorter for softer surfactant particles. Preferably, the ratio of (i) the cake strength of the soft surfactant particle in N to (ii) the time between step (a) and step (b) in minutes is in the range of from 6Nmin⁻¹ to 2000Nmin⁻¹, preferably from 10 Nmin⁻¹, or 25 Nmin⁻¹, or 50 Nmin⁻¹, or 75 Nmin⁻¹, or 100 Nmin⁻¹, or from 150 Nmin⁻¹, or from 200 Nmin⁻¹, and preferably to 1500 Nmin⁻¹, or to 1000 Nmin⁻¹, or to 750 Nmin⁻¹, or to 500 Nmin⁻¹, or even to 400 Nmin⁻¹.

It is highly preferred for the contacting step (b) to occur within three hours, preferably within two hours, preferably within one hour, preferably within forty five minutes, or preferably within thirty minutes, or even within twenty minutes, or even within ten minutes, or even within one minute of the forming step (a). It may be highly preferred for the soft surfactant particle once formed in step (a) to be essentially instantaneously contacted to the free-flowing heterogeneous particulate mixture.

For the purpose of the present invention, and in order to calculate the above ratio of (i) the cake strength of the soft surfactant particle in N to (ii) the time between step (a) and step (b) in minutes, essentially instantaneously means the time between step (a) and step (b) is 0.1 min.

However, due to some manufacturing facility designs it may be necessary to convey (e.g. by pneumatic transport means or belt conveyors) the soft surfactant particle a short distance within the manufacturing facility. In such a situation, the time lag experienced due to conveying the soft surfactant particle typically includes a very short additional time lag period for the soft surfactant particle to be transferred through a small holding vessel (to improve dose accuracy into step (b)). However, any time lag between steps (a) and (b) is as short as possible.

One benefit of conveying the soft surfactant particle is to provide cooling means to the particle. This makes the soft surfactant particle more compatible to any temperature sensitive chemically distinct detergent particle populations to which it may be contacted to in step (b). However, it is desirable to shorten the time between steps (a) and (b) as much as possible. The longer the time gap between steps (a) and (b) the longer the consolidation time for the soft surfactant particles to bridge together to form a consolidated mass, which is difficult to dose into step (b). If the soft surfactant particle is conveyed before being dosed into step (b), it is preferably transported for no more than fifty meters, preferably for no more than forty meters, or no more than thirty meters, or no more than twenty meters, or no more than ten meters.

During the continuous process, liquid may be contacted to the soft surfactant particle and/or the heterogeneous particulate mixture. The liquid may be contacted to any chemically distinct detergent particle population, or any combination thereof. Suitable liquids include non-ionic detersive surfactant, cationic detersive surfactant, perfume, polymer, water, and any combination thereof. Preferably, the liquid is contacted to the soft surfactant particle and the heterogeneous particulate mixture after or during step (b). However, one can of course contact the liquid to the heterogeneous particulate mixture or to some (or even just one) of the chemically distinct detergent particle populations thereof, prior to step (b). For example, a non-ionic detersive surfactant liquid and/or a perfume liquid may be contacted to a spray-dried powder prior to the spray-dried powder being contacted to the soft surfactant particle.

### Step (a): Forming a Soft Surfactant Particle

The soft surfactant particle can be prepared by any suitable means, such as agglomeration, extrusion, mechanical mixing such as screw feeding. Preferably, the soft surfactant particle is prepared by agglomeration. Preferably, the soft surfactant particle is formed by dispersing a surfactant fluid having a viscosity of from about 0.2 Pas to about 100 Pas. The surfactant fluid may be contacted to any suitable powder material, such as spray-dried powder, sodium carbonate, sodium sulphate, sodium silicate, powdered polymeric material, clay, or any mixtures thereof to form the soft surfactant particle. Step (a) is preferably carried out in a mechanical mixer, such as paddle mixer, or a CB lodige, KM lodige, Schugi mixer. Preferably step (a) is carried out in a paddle mixer.

Step (b): Contacting Said Soft Surfactant Particle with a Free-Flowing Heterogeneous Particulate Mixture

The soft surfactant particle is contacted to a free-flowing heterogeneous particulate mixture in any suitable apparatus, such as a mixer or a belt conveyor, preferably a belt conveyor.

### Solid Particulate Laundry Detergent Composition

The solid laundry detergent composition comprises a soft surfactant particle and a free-flowing heterogeneous particulate mixture comprising multiple chemically distinct detergent particle populations. The composition is in free-flowing particulate form, for example such that the composition is in the form of separate discrete particles.

The composition is a fully finished laundry detergent composition. The composition is not just a component of a laundry detergent composition that can be incorporated into a laundry detergent composition (such as a blown powder or an anionic detersive surfactant agglomerate), it is a fully finished laundry detergent composition. That said, it is within the scope of the present invention for an additional rinse additive composition (e.g. fabric conditioner or enhancer), or a main wash additive composition (e.g. bleach additive) to also be used in combination with the laundry detergent composition.

The composition comprises detersive surfactant and preferably other detergent ingredients selected from transition metal catalysts; enzymes such as amylases, carbohydrases, cellulases, laccases, lipases, bleaching enzymes such as oxidases and peroxidases, proteases, pectate lyases and mannanases; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; dyes; fillers such as sodium sulphate, although it is preferred for the composition to be substantially free of fillers; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; bleach activators such as nonanoyloxybenzene sulfonate (NOBS), tetraacetylethylenediamine (TAED) and decanoyloxybenzenecarboxylic acid (DOBA); sources of hydrogen peroxide such as sodium percarbonate and/or sodium perborate; chelants such as ethylene diamine-N′N′-disuccinic acid (EDDS) and/or hydroxyethane diphosphonic acid (HEDP); polymeric carboxylates; zeolite builder; phosphate builder; sodium carbonate and/or sodium bicarbonate, sodium silicate; and any combination thereof.

Preferably, the weight ratio of the soft surfactant particle to the heterogeneous particulate mixture is in the range of from 1:20 to 2:1, or from 1:10, or from 1:5, or from 1:4 and preferably to 1.5:1, or to 1:1.

The composition preferably comprises from 5 wt % to 60 wt %, or from 10 wt %, or from 15 wt %, or from 20 wt %, or from 30 wt %, or from 35 wt %, or from 35 wt %, or even from 40 wt % soft surfactant agglomerate.

As mentioned in more detail above, the process reduces the reliance of process aids such as zeolite. The composition preferably comprises less than 10 wt % zeolite, or less than 8 wt %, or less than 6 wt % or less than 4 wt %, or even less than 2 wt % zeolite. The composition may even be essentially free of (i.e. comprise no deliberately added) zeolite.

### Soft Surfactant Particle

The soft surfactant particle comprises surfactant, preferably anionic detersive surfactant. Other surfactants such as non-ionic detersive surfactants and cationic detersive surfactants may also be suitable. Preferably, the soft surfactant particle comprises from about 15 wt % to about 60 wt % surfactant, preferably from about 20 wt % of from 25 wt % or from 30 wt %, or from 35 wt %, or even from 40 wt % surfactant.

The soft surfactant particle preferably has cake strength of from about 30N to about 200N, preferably from 40N, or from 50N, or from 60N, or from 70N, or from 80N, or from 100N.

The soft surfactant particle preferably comprises from above 0 wt % to about 10 wt % water.

The soft surfactant particle preferably has a weight average particle size of from about 200 micrometers to about 1000 micrometers.

### Free-Flowing Heterogeneous Particulate Mixture

The free-flowing heterogeneous particulate mixture comprises multiple (i.e. more than two) chemically distinct detergent particle populations. Preferably, the free-flowing heterogeneous particulate mixture comprises at least three, or even at least four, or at least five, or at least six, or at least seven, or at least eight, or at least nine, or even at least ten chemically distinct detergent particle populations.

Preferably, the free-flowing heterogeneous particulate mixture has a cake strength of from 0N to 20N, preferably from 0N to 15N, or from 0N to 10N, or from 0N to 5N. Preferably, the free-flowing heterogeneous particulate mixture has a cake strength of 0N.

Preferably, the free-flowing heterogeneous particulate mixture has a weight average particle size of from about 50 micrometers to 2000 micrometers, or preferably from 100 micrometers, or from 150 micrometers, or from 200 micrometers, or to 1500 micrometers, or to 1000 micrometers.

Preferably, the free-flowing heterogeneous particulate mixture comprises at least three chemically distinct detergent particle populations, preferably selected from the group consisting of: sodium carbonate particles; sodium percarbonate particles; anionic detersive surfactant particles; cationic detersive surfactant particles; anionic polymer particles; cationic polymer particles; sodium silicate particles; enzyme particles; hueing agent particles; brightener particles; perfume particles; and sodium sulphate particles.

### Chemically Distinct Detergent Particle Populations

A chemically distinct detergent particle population is a population of particles having substantially the same chemical composition. For example, a conventional spray-dried powder comprising a mixture of organic ingredients such as alkyl benzene sulphonate and inorganic materials such as sodium carbonate, is a mixture of particles having different particle sizes but having substantially the same chemical composition. By substantially the same chemical composition it allows for the changes in the weight ratios of the ingredients due to the usual processing variability. For example in the spray-dried powder example illustrated above, it is typical that the smaller particles of the spray-dried powder population comprise higher percentages of organic material such as surfactants compared to larger particles.

As well as spray-dried powder, chemically distinct detergent particle populations can be selected from the group consisting of: sodium carbonate particles; sodium percarbonate particles; anionic detersive surfactant particles; cationic detersive surfactant particles; anionic polymer particles; cationic polymer particles; sodium silicate particles; enzyme particles; hueing agent particles; brightener particles; perfume particles; and sodium sulphate particles.

### Method for Measuring Cake Strength

A smooth plastic cylinder of internal diameter 63.5 mm and length 15.9 cm is supported on a suitable base plate. A 0.65 cm hole is drilled through the cylinder with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the particulate material such that the particulate material is level with the top of the sleeve. A lid is placed on top of the sleeve and a 5 kg weight placed on the lid. The pin is then pulled out and the powder is allowed to compact for 2 minutes. After 2 minutes the weight is removed, the sleeve is lowered to expose the powder cake with the lid remaining on top of the powder.

A metal probe is then lowered at 54 cm/min such that it contacts the centre of the lid and breaks the cake. The maximum force required to break the cake is recorded and is the result of the test. A cake strength of 0N refers to the situation where no cake is formed.

### EXAMPLES

An 70 wt % active ethoxylated alkyl sulphate fluid is dispersed and blended with a spray-dried powder in a lodige CB30 mixer operating at 420 rpm to form a soft surfactant particle. The powder (i.e. spray-dried powder) throughput is 400 kgh⁻¹, and the liquid (i.e. surfactant) throughput is 80 kgh⁻¹.

Substantially immediately the soft surfactant particle is dosed onto a belt conveyor and contacted with a free-flowing heterogeneous particulate mixture comprising: more of the same spray-dried particles that were dosed into the lodige CB30 mixer as described above; protease prills; amylase prills; cellulase prills; lipase prills; sodium carbonate particles; sodium sulphate particles; TAED bleach activator particles; coated sodium percarbonate particles; perfume microcapsule agglomerates; chelant particles; suds suppressor particles. The weight ratio of the soft surfactant particle to the free-flowing heterogeneous particulate mixture is 1:1.5.

The resultant mixture is transferred to a mix drum, where perfume oil is sprayed onto the powder to form a solid particulate laundry detergent composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A continuous process for making a solid particulate laundry detergent composition comprising the steps of:
(a) forming a soft surfactant particle having a cake strength of from about 30N to about 200N; and
(b) contacting said soft surfactant particle with a free-flowing heterogeneous particulate mixture comprising multiple chemically distinct detergent particle populations,
wherein said free-flowing heterogeneous particulate mixture has a cake strength of from about 0N to about 20N,
wherein said free-flowing heterogeneous particulate mixture has a weight average particle size of from about 50 micrometers to 2000 micrometers, and
wherein the ratio of (i) the cake strength of the soft surfactant particle in N to (ii) the time between step (a) and step (b) in minutes is in the range of from 6Nmin⁻¹ to 2000Nmin⁻¹.

2. A process according to claim 1, wherein said soft surfactant particle is formed by dispersing a surfactant fluid a viscosity of from about 0.5 Pas to about 100 Pas.

3. A process according to claim 1, wherein in step (b) said soft surfactant particle is contacted to said free-flowing heterogeneous particulate mixture on a belt conveyor.

4. A process according to claim 1 wherein the contacting step (b) occurs within three hours of the forming step (a).

5. A process according to claim 1 wherein the contacting step (b) occurs within thirty minutes of the forming step (a).

6. A process according to claim 1, wherein the soft surfactant particle comprises anionic detersive surfactant.

7. A process according to claim 1, wherein the soft surfactant particle comprises from above 0 wt % to about 10 wt % water.

8. A process according to claim 1 wherein the soft surfactant particle has a weight average particle size of from about 200 micrometers to about 1000 micrometers.

9. A process according to claim 1 wherein the free-flowing heterogeneous particulate mixture comprises at least three chemically distinct detergent particle populations selected from the group consisting of: sodium carbonate particles; sodium percarbonate particles; anionic detersive surfactant particles; cationic detersive surfactant particles; anionic polymer particles; cationic polymer particles; sodium silicate particles; enzyme particles; hueing agent particles; brightener particles; perfume particles; and sodium sulphate particles.

10. A process according to claim 1, wherein weight ratio of the soft surfactant particle to the heterogeneous particulate mixture 1:20 to 2:1.

11. A process according to claim 1, wherein liquid is contacted to the soft surfactant particle and/or the heterogeneous particulate mixture.

12. A process according to claim 1, wherein the soft surfactant particle comprises from about 15 wt % to about 60 wt % surfactant.

13. A process according to claim 1, wherein the soft surfactant particle has a cake strength of at least about 40N.

14. A process according to claim 1, wherein said free-flowing heterogeneous particulate mixture has a cake strength of from about 0N to about 10N

15. A process according to claim 1, wherein the ratio of (i) the cake strength of the soft surfactant particle in N to (ii) the time between step (a) and step (b) in minutes is in the range of from 200Nmin⁻¹ to 400Nmin⁻¹.
